(19) United States
(12) Patent Application Publication
(10) Pub. No.: US 2023/0116445 A1
(43) Pub. Date: Apr. 13, 2023

(54) ANGLED JOINT PANELS AND GARDEN BEDS HAVING SAME

(71) Applicant: Vego Garden Inc, Houston, TX (US)

(72) Inventor: Guangyuan Xiong, Houston, TX (US)

(21) Appl. No.: 17/949,005

(22) Filed: Sep. 20, 2022

Related U.S. Application Data
(60) Provisional application No. 63/247,869, filed on Sep. 24, 2021.

(51) Int. Cl. A01G 9/28

(52) U.S. Cl. CPC A01G 9/28

(57) ABSTRACT

An angled joint panel and a garden bed therewith. The angled joint panel comprise a first wing comprising a plurality of sections; a second wing comprising a plurality of sections; a backbone hinge adjoining the first wing and the second wing; and an angled formed between the first wing and the second wing ranges between about 1 to about 359 degree.

### CROSS-REFERENCE TO RELATED PATENT APPLICATIONS

This application claims priority to and the benefit of U.S. Provisional Pat. Application Serial No. 63/247,869, filed Sep. 24, 2021, which is incorporated herein in its entirety by reference.

### FIELD OF THE INVENTION

The present disclosure relates generally to the garden bed assembly. In particular, the invention is directed to angled joint panels used for the garden bed assembly, and applications of the same.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

Raised garden beds are a preferred way to grow the plants within an established area by many professional gardeners and amateur home owners. The use of raised garden beds is particularly widespread in areas in which the soil is poor and/or where good drainage is required.

Raised garden beds are provided in many forms. Common raised garden beds are often constructed of wall panels which have a long-narrow plank shape, and are made of rigid or semi-rigid materials, e.g., metal, plastic, or wood. The rigid or semi-rigid materials would help the garden beds to withhold the pressure of the soil and the water in the bed. These rigid or semi-rigid materials also improve the garden beds’ capability to withstand the weather as outdoor fixtures. Joints are used to connect more than one wall panels, so as to form a peripherally enclosed structure.

However, one significant drawback of the using of rigid and semi-rigid materials is their limitation with respect to the shape of the garden beds. Due to its rigidness, these materials are either unbendable completely, or only bendable in a very limited degree. Therefore, the shape of the garden beds is significantly limited, such that the built garden beds may not meet the artistic design expectation, and building of the garden beds are extremely time consuming.

Therefore, a need exists for garden beds which could be built into more diversed shapes, less building-time consuming, and have higher artistic design value.

### SUMMARY OF THE INVENTION

In light of the foregoing, this invention discloses angled joint panels and their application in garden beds construction. The angle joint panel in one embodiment includes two wings joined together by a backbone hinge to define an angle therewith. The angled joint panel revolutionizes the modularity of raised garden beds. The angled joint panel is designed to be easily manufactured, with the angle formed between the two wings ranges from 1 to 359 degree. It allows one to assemble a garden bed into a myriad of new shapes. With the angled joint panel, one can build an L or U-shaped garden bed, a heart, a diamond, a clover, a cross, a triangle, a pentagon, a hexagon, an octagon, or any other shapes desired.

In one aspect of the invention, an angled joint panel for a garden bed, the angled joint panel comprising a first wing comprising a plurality of sections; a second wing comprising a plurality of sections; a backbone hinge adjoining the first wing and the second wing; and wherein an angled formed between the first wing and the second wing ranges between about 1 to about 359 degree.

In one embodiment, the backbone hinge is configured to be adjustable such that the angle formed between the first wing and the second wing is adjustable for at least 90 degree.

In one embodiment, the backbone hinge is configured to be adjustable such that the angle formed between the first wing and the second wing is adjustable for at least 60 degree.

In one embodiment, the backbone hinge is configured to be adjustable such that the angle formed between the first wing and the second wing is adjustable for at least 30 degree.

In one embodiment, the backbone hinge is bendable and adjustable and the angle formed between the first wing and the second wing is adjustable to an angle selected from the group consisting of 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350 and 355 degrees.

In another embodiment, the backbone hinge is not bendable and not adjustable and the angle formed between the first wing and the second wing is a fixed angle selected from the group consisting of 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350 and 355 degrees.

In one embodiment, the angled joint panel have a height defined between two ends of the backbone hinge. The height can be any of 5-50 inches. In addition, the height may be selected from the group consisting of 5, 6, 8, 10, 12, 14, 16, 18, 20, 22, 24, 26, 28, 30, 32, 34, 36, 38, 40, 42, 44, 46, 48 and 50 inches.

In one embodiment, each of the plurality of sections has a curved/wave profile/pattern such that the first and second wings each has a sinusoidal configuration.

In one embodiment, each of the plurality of sections has a triangle profile/pattern such that the first and second wings each has a triangle jagged configuration.

In one embodiment, each of the plurality of sections has a rectangular profile/pattern such that the first and second wings each has a rectangular jagged configuration.

In one embodiment, each of the plurality of sections has a fastening hole for receiving a fastener.

In one embodiment, the angled joint panel is connected to a wall panel by the fastener.

In one embodiment, the wall panel has at least one receiving hole, wherein the fastener is simultaneously received through the fastening hole of the angled joint panel and the receiving hole of the wall panel.

In another aspect of the invention, an angled joint panel for a garden bed, the angled joint panel comprising a first wing comprising a plurality of curved sections; a second wing comprising a plurality of curved sections; a backbone hinge adjoining the first wing and the second wing; and wherein an angled formed between the first wing and the second wing ranges between about 1 to about 359 degree; wherein the backbone hinge is configured to be adjustable such that the angle formed between the first wing and the second wing is adjustable for at least 90 degree; wherein the first and second wings each has a sinusoidal configuration; wherein each of the plurality of curved sections has a fastening hole for receiving a fastener connecting the angled joint panel to a wall panel of the garden bed.

In a further aspect of the invention, a garden bed comprises one or more wall panels; and one or more angled joint panels for connecting the one or more wall panels to form the garden bed in a desired shape, each of the one or more angled joint panel is according to any one of the above angled joint panels.

In one embodiment, the desired shape includes an L shape, a U shape, a heart shape, a diamond shape, a clover shape, a cross shape, a triangle profile/shape, a pentagon shape, a hexagon shape, an octagon shape, or the like.

In one embodiment, the angled joint panel and the wall panel are made of the same material or different materials, the material(s) include, but are not limited to, steel, aluminum, alloy, plastics, polymers, fiberglass, and the likes.

These and other aspects of the present invention will become apparent from the following description of the preferred embodiments, taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 depicts a perspective view of an outer surface of an angled joint panel according to embodiments of the invention.

FIG. 2 depicts another perspective view of the outer surface of the angled joint panel shown in FIG. 1.

FIG. 3 depicts a perspective view of an inner surface of the angled joint panel shown in FIG. 1.

FIG. 4 depicts another perspective view of the inner surface of the angled joint panel shown in FIG. 1.

FIG. 5 depicts a side perspective view of the angled joint panel shown in FIG. 1.

FIG. 6 depicts a top perspective view of the angled joint panel shown in FIG. 1.

FIG. 7 depicts the two garden bed wall panels joined by the angled joint panel according to embodiments of the invention.

FIG. 8 depicts a perspective view of an L-shaped garden bed constructed by the angled joint panel(s) and garden bed wall panel(s) according to embodiments of the invention.

FIG. 9 depicts a perspective view of an U-shaped garden bed constructed by the angled joint panel(s) and garden bed wall panel(s) according to embodiments of the invention.

FIG. 10 depicts a perspective view of a clover shaped garden bed constructed by the angled joint panel(s) and garden bed wall panel(s) according to embodiments of the invention.

FIG. 11 depicts a perspective view of a cross shaped garden bed constructed by the angled joint panel(s) and garden bed wall panel(s) according to embodiments of the invention.

FIG. 12 depicts a perspective view of an octagon shaped garden bed constructed by the angled joint panel(s) and garden bed wall panel(s) according to embodiments of the invention.

FIG. 13 depicts a perspective view of a hexagon shaped garden bed constructed by the angled joint panel(s) and garden bed wall panel(s) according to embodiments of the invention.

FIG. 14 depicts a perspective view of a pentagon shaped garden bed constructed by the angled joint panel(s) and garden bed wall panel(s) according to embodiments of the invention.

FIG. 15 depicts a perspective view of a triangle profile/shaped garden bed constructed by the angled joint panel(s) and garden bed wall panel(s) according to embodiments of the invention.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed may be resorted to by those skilled in the art, and that such modifications and variations are considered to be within the scope of this invention as defined by the appended claims.

Whenever a range is given in the specification, for example, a temperature range, a time range, or a composition or concentration range, all intermediate ranges and subranges, as well as all individual values included in the ranges given are intended to be included in the invention. It will be understood that any subranges or individual values in a range or subrange that are included in the description herein can be excluded from the claims herein.

It will be understood that, as used in the description herein and throughout the claims that follow, the meaning of “a”, “an”, and “the” includes plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element’s relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising”, or “includes” and/or “including”, or “has” and/or “having”, or “carry” and/or “carrying”, or “contain” and/or “containing”, or “involve” and/or “involving”, “characterized by”, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

As used in the disclosure, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in the disclosure, the phrase “at least one of A, B, and C” should be construed to mean a logical (A or B or C), using a non-exclusive logical OR. As used herein, the term “and/or” includes any and all combinations of one or more of the associated listed items.

As used in the disclosure, “bendable” or “bendability” refers to a mechanical property indicating the ability of a material, structure, device or device component to be deformed into a curved or angled shape without undergoing a transformation that introduces significant strain, such as strain characterizing the failure point of a material, structure, device or device component.

As used in the disclosure, “stiffness” refers to an extent to which a material, structure, system, or feature resists deformation in response to an applied force. Stiffness corresponds to a ratio of force applied to a material, structure, or element versus the displacement produced by the applied force along the same degree of freedom (e.g., same axis or direction) exhibited by the material, structure, or element. In an embodiment, the stiffness of a material, structure, or element is the Young’s modulus of the material, structure, or element.

Present system described herein features angled joint panels and its application in garden beds. The angle j oint panel in one embodiment includes two wings jointed together by a backbone hinge to define an angle therewith. The angled joint panel revolutionizes the modularity of raised garden beds. The angled joint panel is designed to be easily manufactured, with the angle formed between the two wings ranges from 1 to 359 degree. It allows one to assemble a garden bed into a myriad of new shapes. With the angled joint panel, one can build a garden bed in any shape, such as, but is not limited to, an L shape, a U shape, a heart shape, a diamond shape, a clover-shape, a cross shape, a triangle profile/shape, a pentagon shape, a hexagon shape, an octagon shape, or any other shapes desired.

In one embodiment, the two wings of the angled joint panel are designed to fit seamlessly against the wall panels of the garden beds to form a polished edge, allowing the edging cover to cover the upper and/or lower rim of the wall panels/angled joint panels, and create a safe edge, protecting the gardener from injuries such as cuts and abrasions by the rims of the wall panels/angled joint panels.

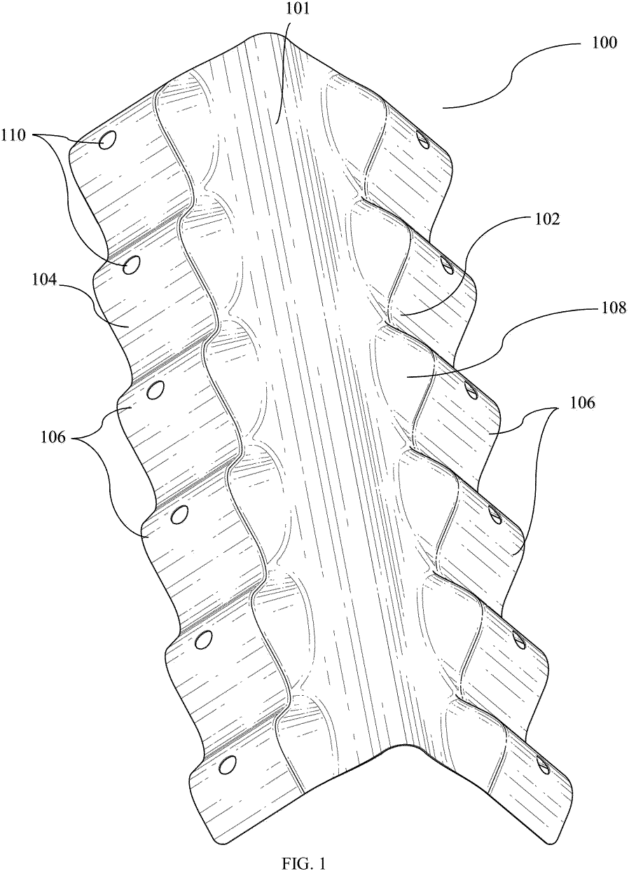

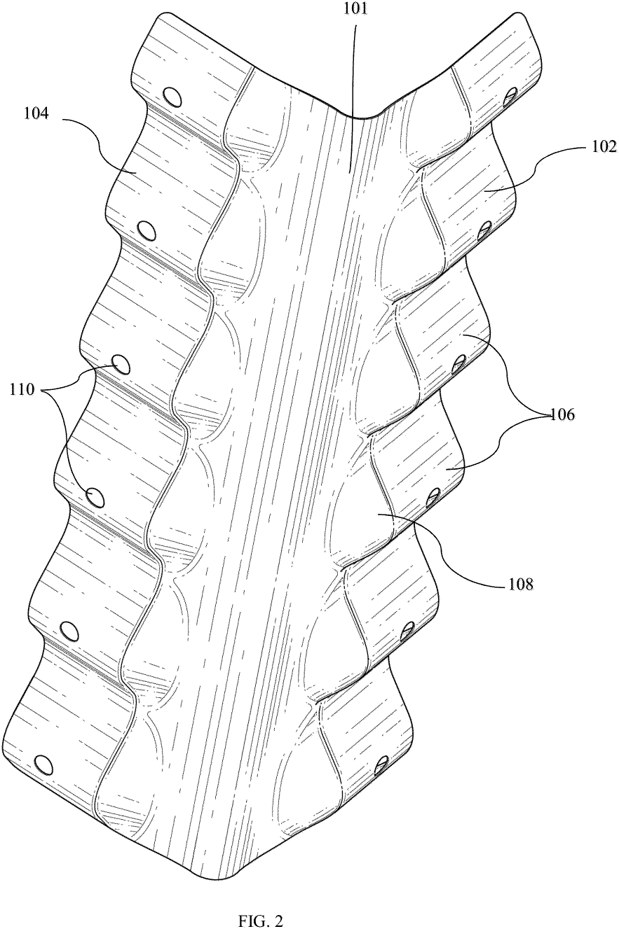

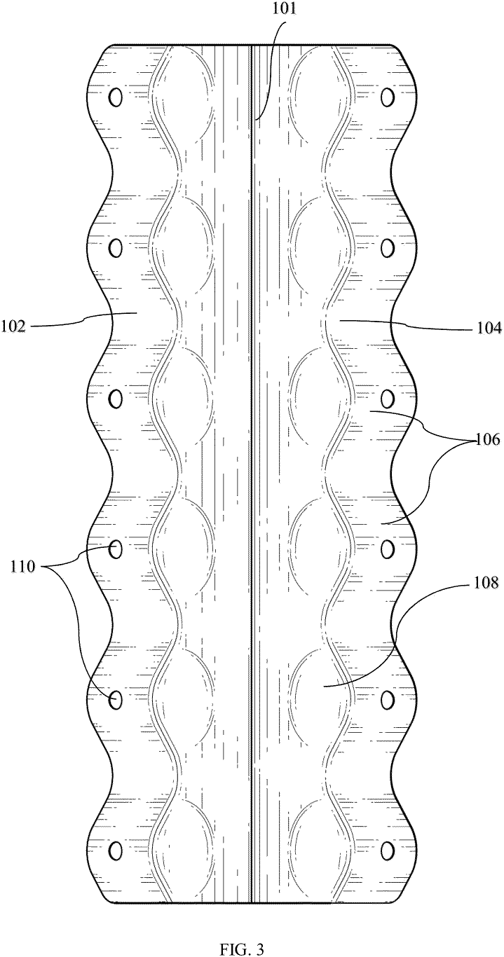

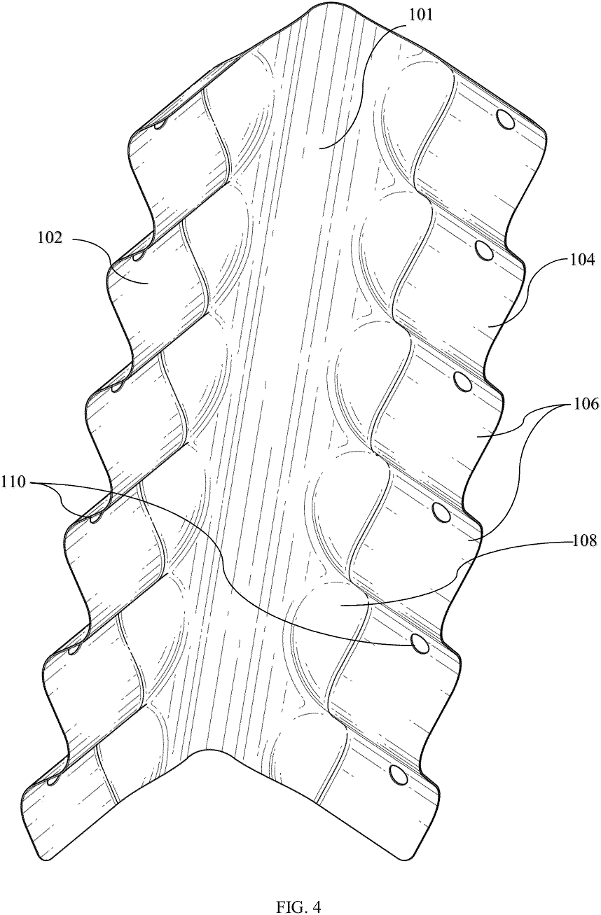

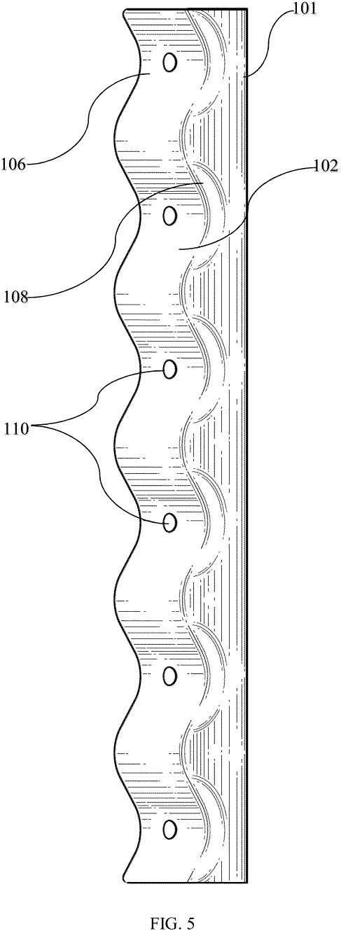

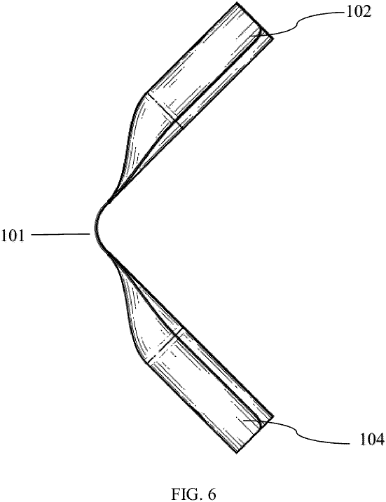

FIGS. 1-6 show different perspective views of the angled joint panel 100 according to embodiments of the invention. The angled joint panel 100 includes a right wing 102 and a left wing 104 adjoined by a backbone hinge 101.

In one embodiment, each of the right wing 102 and left wing 104 has a sinusoidal configuration which includes a plurality of curved sections 106. The sinusoidal configuration is formed by a linear continuous arrangement of the curved sections 106. In one embodiment, instead of a sinusoidal configuration, each of the right wing 102 and left wing 104 has a triangle jagged configuration in which each of the wings includes a plurality of triangle sections 106. The triangle jagged configuration is formed by a linear continuous arrangement of the triangle sections 106. In one embodiment, the triangle sections 106 have rounded corners. In one embodiment, each of the right wing 102 and left wing 104 has a square/rectangular jagged configuration, in which each of the right wing 102 and the left wing 104 includes a plurality of square/rectangular sections 106. The square/rectangular jagged configuration is formed by a linear continuous arrangement of the square/rectangular sections 106. In one embodiment, the square/rectangular sections 106 have rounded corners.

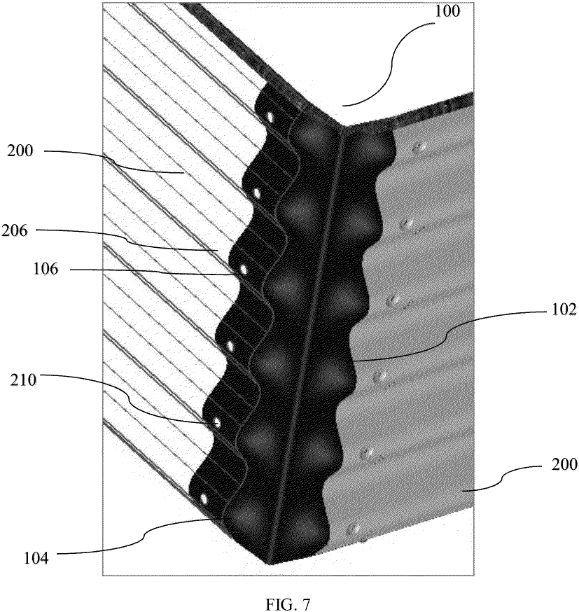

As shown in FIG. 7, the configuration of the right and left wings 102 and 104 seamlessly matches with the configuration of the wall panels 200 of the garden beds. For example, when the right and left wings 102/104 of the angled joint panel have a sinusoidal configuration including a plurality of curved sections 106, the wall panel 200 also has a sinusoidal configuration including a plurality of curved sections 206. The curved sections 106 of the angled joint panel 100 and the curved sections 206 of the wall panel 200 have the same amplitude and period such that the wall panel 200 and the angled joint panel 100 would be seamlessly connected to each other. This seamless connection formed by the same configuration between the wall panel 200 and the angled j oint panel 100 is also applied to triangle jagged configuration and the square/rectangular jagged configuration.

The right and left wings 102/104 are adjoined together by a backbone hinge 101, as shown in the FIGS. 1-6. In one embodiment, the backbone hinge 101 is manufactured differently to have the right and left wings 102/104 forming a predetermined angle that ranges from about 1 to 359 degree. In one embodiment, the backbone hinge 101 is not adjustable and is manufactured to have the right and left wings 102/104 forming a fixed angle of 90 degree. In other embodiments, the backbone hinge 101 is not bendable and not adjustable and is manufactured to have the right and left wings 102/104 forming a fixed angle selected from the group consisting of 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350 and 355 degrees.

In one embodiment, the manufactured backbone hinge 101 is bendable such that the angle formed between the right and left wings 102/104 can be adjusted to accommodate the the gardener’s need or the garden bed design. In one embodiment, the manufactured backbone hinge 101 can be bended to adjust the angle formed between the right and left wings 102/104 for about 10 degree. That is, when an angled joint panel 100 is manufactured to form a 90 degree angle between its right and left wings 102/104, the backbone hinge 101 can be bended to adjust the angle formed between the right and left wings 102/104 to a 100 degree or an 80 degree.

In other embodiments, the backbone hinge 101 can be bended such that the angle formed between the right and left wings 102/104 can be adjusted to have a degree selected from the group consisting of 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350 and 355 degrees.

Therefore, it will be readily appreciated that the bendability of the backbone hinge 101, in combination with the variety of the angle into which the angled joint panel 100 can be manufactured, makes the angled joint panel 100 of the present invention can form an angle of any degree between 1 to 359, such that the garden bed can be constructed into any shape desired with the angled joint panel 100 of the present invention.

In one embodiment, the angle formed between the right and left wings of the angled joint panel ranges from about 1 to about 30 degree. In one embodiment, the angle formed between the right and left wings of the angled joint panel ranges from about 1 to about 45 degree. In one embodiment, the angle formed between the right and left wings of the angled joint panel ranges from about 1 to about 60 degree. In one embodiment, the angle formed between the right and left wings of the angled joint panel ranges from about 1 to about 75 degree. In one embodiment, the angle formed between the right and left wings of the angled joint panel ranges from about 1 to about 90 degree. In one embodiment, the angle formed between the right and left wings of the angled joint panel ranges from about 1 to about 105 degree. In one embodiment, the angle formed between the right and left wings of the angled joint panel ranges from about 1 to about 120 degree. In one embodiment, the angle formed between the right and left wings of the angled joint panel ranges from about 1 to about 135 degree. In one embodiment, the angle formed between the right and left wings of the angled joint panel ranges from about 1 to about 150 degree. In one embodiment, the angle formed between the right and left wings of the angled joint panel ranges from about 1 to about 165 degree. In one embodiment, the angle formed between the right and left wings of the angled joint panel ranges from about 1 to about 180 degree.

In one embodiment, the angle formed between the right and left wings of the angled joint panel ranges from about 30 to about 45 degree. In one embodiment, the angle formed between the right and left wings of the angled joint panel ranges from about 30 to about 60 degree. In one embodiment, the angle formed between the right and left wings of the angled joint panel ranges from about 30 to about 90 degree. In one embodiment, the angle formed between the right and left wings of the angled joint panel ranges from about 30 to about 105 degree. In one embodiment, the angle formed between the right and left wings of the angled joint panel ranges from about 30 to about 120 degree. In one embodiment, the angle formed between the right and left wings of the angled joint panel ranges from about 30 to about 135 degree. In one embodiment, the angle formed between the right and left wings of the angled joint panel ranges from about 30 to about 150 degree. In one embodiment, the angle formed between the right and left wings of the angled joint panel ranges from about 30 to about 180 degree.

In one embodiment, the angle formed between the right and left wings of the angled joint panel ranges from about 45 to about 60 degree. In one embodiment, the angle formed between the right and left wings of the angled joint panel ranges from about 45 to about 90 degree. In one embodiment, the angle formed between the right and left wings of the angled joint panel ranges from about 45 to about 105 degree. In one embodiment, the angle formed between the right and left wings of the angled joint panel ranges from about 45 to about 120 degree. In one embodiment, the angle formed between the right and left wings of the angled joint panel ranges from about 45 to about 135 degree. In one embodiment, the angle formed between the right and left wings of the angled joint panel ranges from about 45 to about 150 degree. In one embodiment, the angle formed between the right and left wings of the angled joint panel ranges from about 45 to about 180 degree.

In one embodiment, the angle formed between the right and left wings of the angled joint panel ranges from about 60 to about 90 degree. In one embodiment, the angle formed between the right and left wings of the angled joint panel ranges from about 60 to about 105 degree. In one embodiment, the angle formed between the right and left wings of the angled joint panel ranges from about 60 to about 120 degree. In one embodiment, the angle formed between the right and left wings of the angled joint panel ranges from about 60 to about 135 degree. In one embodiment, the angle formed between the right and left wings of the angled joint panel ranges from about 60 to about 150 degree. In one embodiment, the angle formed between the right and left wings of the angled joint panel ranges from about 60 to about 180 degree.

In one embodiment, the angle formed between the right and left wings of the angled joint panel ranges from about 90 to about 105 degree. In one embodiment, the angle formed between the right and left wings of the angled joint panel ranges from about 90 to about 120 degree. In one embodiment, the angle formed between the right and left wings of the angled joint panel ranges from about 90 to about 135 degree. In one embodiment, the angle formed between the right and left wings of the angled joint panel ranges from about 90 to about 150 degree. In one embodiment, the angle formed between the right and left wings of the angled joint panel ranges from about 90 to about 180 degree.

In one embodiment, the angle formed between the right and left wings of the angled joint panel ranges from about 105 to about 120 degree. In one embodiment, the angle formed between the right and left wings of the angled joint panel ranges from about 105 to about 135 degree. In one embodiment, the angle formed between the right and left wings of the angled joint panel ranges from about 105 to about 150 degree. In one embodiment, the angle formed between the right and left wings of the angled joint panel ranges from about 105 to about 180 degree.

In one embodiment, the angle formed between the right and left wings of the angled joint panel ranges from about 120 to about 135 degree. In one embodiment, the angle formed between the right and left wings of the angled joint panel ranges from about 120 to about 150 degree. In one embodiment, the angle formed between the right and left wings of the angled joint panel ranges from about 120 to about 180 degree.

In one embodiment, the angled joint panel have a height defined between two ends of the backbone hinge. The height can be any of 5-50 inches. In addition, the height may be selected from the group consisting of 5, 6, 8, 10, 12, 14, 16, 18, 20, 22, 24, 26, 28, 30, 32, 34, 36, 38, 40, 42, 44, 46, 48 and 50 inches.

In one embodiment, the angled joint panel and the wall panel are made of the same material or different materials, the material(s) include, but are not limited to, steel, aluminum, alloy, plastics, polymers, fiberglass, and the likes. Further, the joint panel can be manufactured at different heights, different wave profiles/patterns such as, but are not limited to, a sinusoidal configuration, a triangle jagged configuration and a rectangular jagged configuration. Moreover, the joint panel can be connected by different quantities of bolts. The joint panel in one embodiment is bendable by machine or hand. In another embodiment, it is manufactured to have different fixed angles and not easily to be changed by hand.

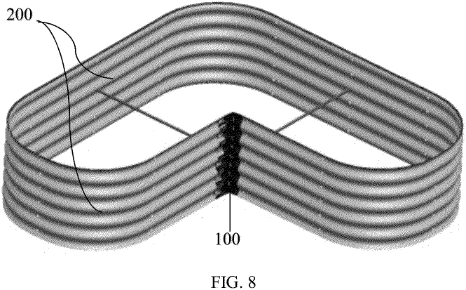

As shown in FIGS. 8-15, with the angled joint panel 100, one can build an L or U-shaped garden bed, a heart shaped garden bed, a diamond shaped garden bed, a clover shaped garden bed, a cross shaped garden bed, a triangle profile/shaped garden bed, a pentagon shaped garden bed, a hexagon shaped garden bed, or even an octagon shaped garden bed.

FIG. 8 shows a garden bed of a heart shaped/L-shaped built with an angled joint panel 100 having about 90 degree angle between its right and left wings 102/104. The angled joint panel 100 being used can be manufactured into a 90 degree. In another embodiment, the angled joint panel 100 being used can be manufactured into a degree different from 90 degree and being bended at the backbone hinge 101 so as to adjust the angle to about 90 degree.

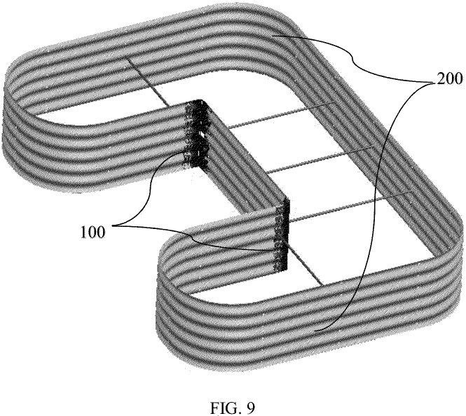

FIG. 9 shows a garden bed of an U-shaped built with two angled joint panels 100 having about 90 degree angle between the right and left wings 102/104. The two angled joint panels 100 being used can be manufactured into a 90 degree. In another embodiment, the angled joint panels 100 being used can be manufactured into a degree different from 90 degree and being bended at the backbone hinge 101 so as to adjust the angle to about 90 degree.

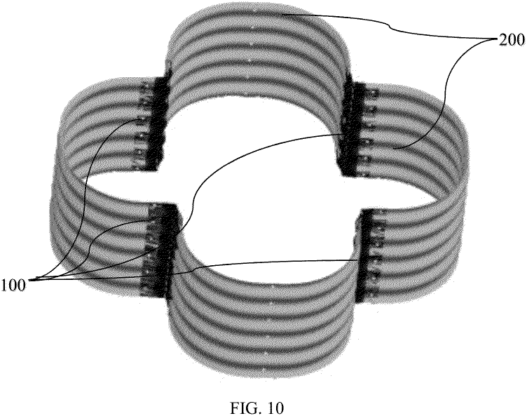

FIG. 10 shows a garden bed of a clover shape built with four angled joint panels 100, each having an angle between 90-120 degrees between the right and left wings 102/104. The four angled joint panels 100 being used can be manufactured into a degree between 90-120. In another embodiment, the angled joint panels 100 being used can be manufactured into a degree different from 90-120 degree and being bended at the backbone hinge 101 so as to adjust the angle to a degree between 90-120.

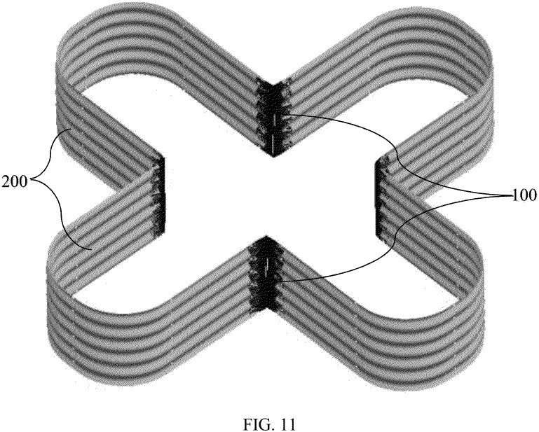

FIG. 11 shows a garden bed of a cross shape built with four angled joint panels 100, each having an angle between 90-120 degree between the right and left wings 102/104. The four angled joint panels 100 being used can be manufactured into a degree between 90-120. In another embodiment, the angled joint panels 100 being used can be manufactured into a degree different from 90-120 degree and being bended at the backbone hinge 101 so as to adjust the angle to a degree between 90-120.

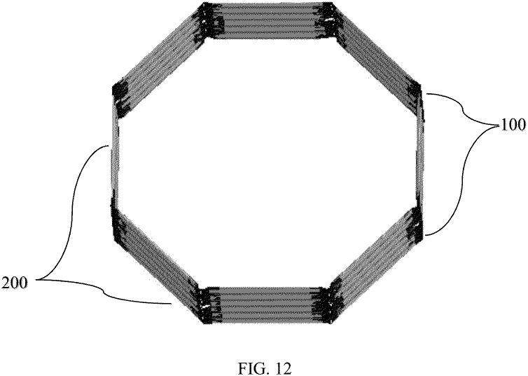

FIG. 12 shows a garden bed of an octagon shape built with eight angled joint panel 100 each having about 135 degree angle between the right and left wings 102/104. The angled joint panels 100 being used can be manufactured into a 135 degree. In another embodiment, the angled joint panels 100 being used can be manufactured into a degree different from 135 degree and being bended at the backbone hinge 101 so as to adjust the angle to about 135 degree.

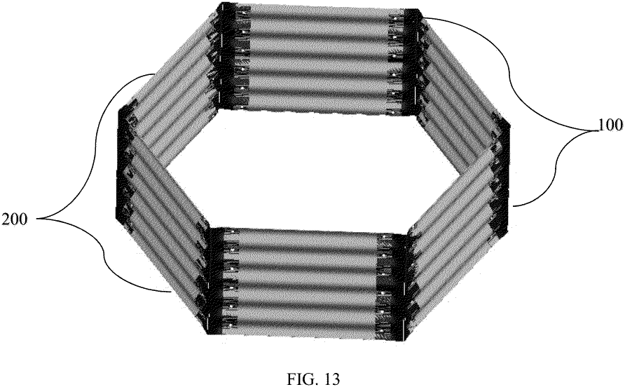

FIG. 13 shows a garden bed of a hexagon shape built with six angled joint panel 100 each having about 120 degree angle between the right and left wings 102/104. The angled joint panels 100 being used can be manufactured into a 120 degree. In another embodiment, the angled joint panels 100 being used can be manufactured into a degree different from 120 degree and being bended at the backbone hinge 101 so as to adjust the angle to about 120 degree.

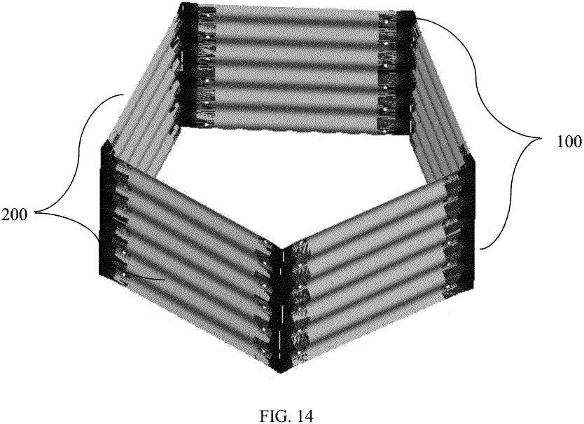

FIG. 14 shows a garden bed of a pentagon shape built with five angled joint panel 100 each having about 108 degree angle between the right and left wings 102/104. The angled joint panels 100 being used can be manufactured into a 108 degree. In another embodiment, the angled joint panels 100 being used can be manufactured into a degree different from 108 degree and being bended at the backbone hinge 101 so as to adjust the angle to about 108 degree.

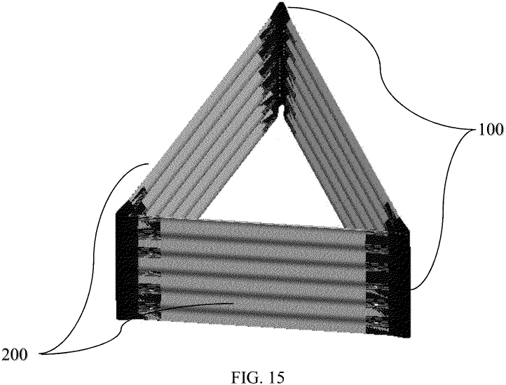

FIG. 15 shows a garden bed of a triangle profile/shape built with three angled joint panel 100 each having about 60 degree angle between the right and left wings 102/104. The angled joint panels 100 being used can be manufactured into a 60 degree. In another embodiment, the angled joint panels 100 being used can be manufactured into a degree different from 60 degree and being bended at the backbone hinge 101 so as to adjust the angle to about 60 degree.

It will be readily appreciated that FIGS. 8-15 are for exemplary purpose, and garden beds having other shapes can be constructed with the angled joint panel(s) 100 and wall panel(s) 200.

As shown in FIGS. 1-6, the curved section 106 and the backbone hinge 101 are adjoined by a transient section 108.

As shown in FIGS. 1-6, the curved section 106 has a fastening hole 110 for receiving a fastener therethrough. In one embodiment, a right/left wing 102/104 having a sinusoidal configuration has a plurality of the curved sections 106. Each of the curved section 106 includes a fastening hole 110. In one embodiment, the fastening hole 110 locates at the peak of the each curved section 106. In another embodiment, the fastening hole 110 locates off the peak of the curved section 106.

As shown in FIG. 7, when the angled joint panel 100 and the wall panel 200 are connected, the curved section 106 and curved section 206 are aligned and partially overlapped with each other. Thus, each fastening hole 110 on the angled joint panel 100 is aligned with a receiving hole 210 locates on the wall panel 200, such that a fastener e.g. a blot, a screw, a cork, and etc., is received through a pair of aligned fastening hole 110 and receiving hole 210.

It will be readily appreciated that the fastening holes 110 may locate at any places of the right and left wings 102/104, as long as each of the fastening holes 110 on the angled joint panel 100 can be aligned with each of the receiving holes 210 on the wall panel 200 respectively, such that a fastener can be simultaneously received by a fastening hole 110 and a receiving hole 210. The angled joint panel 100 and the wall panel 200 are therefore seamlessly connected by the fastener received through the fastening hole 110 and the receiving hole 210.

In one embodiment, the left and right wings 102/104 of the angled joint panel 100 are designed to fit seamlessly against the wall panels of the garden beds to form a polished edge, allowing the edging cover to cover the upper and/or lower rim of the wall panels and the angled joint panels, and create a safe edge, protecting the gardener from injuries such as cuts and abrasions by the rims of the wall panels/angled joint panels.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. An angled joint panel for a garden bed, the angled joint panel comprising:
a first wing comprising a plurality of first sections;
a second wing comprising a plurality of second sections;
a backbone hinge adjoining the first wing and the second wing; and
wherein an angle formed between the first wing and the second wing ranges between about 1 to about 359 degree.

2. The angled joint panel according to claim 1, wherein the backbone hinge is configured to be adjustable such that the angle formed between the first wing and the second wing is adjustable for at least 90 degree.

3. The angled joint panel according to claim 1, wherein the backbone hinge is configured to be adjustable such that the angle formed between the first wing and the second wing is adjustable for at least 60 degree.

4. The angled joint panel according to claim 1, wherein the backbone hinge is configured to be adjustable such that the angle formed between the first wing and the second wing is adjustable for at least 30 degree.

5. The angled joint panel according to claim 1, wherein the backbone hinge is not adjustable and the angle formed between the first wing and the second wing is a fixed angle selected from the group consisting of 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350 and 355 degrees.

6. The angled joint panel according to claim 1, having a height in a range of 5-50 inches.

7. The angled joint panel according to claim 6, wherein the height is selected from the group consisting of 5, 6, 8, 10, 12, 14, 16, 18, 20, 22, 24, 26, 28, 30, 32, 34, 36, 38, 40, 42, 44, 46, 48 and 50 inches.

8. The angled joint panel according to claim 1, wherein each of the first and second sections has a curved/wave profile/pattern such that each of the first and second wings has a sinusoidal configuration.

9. The angled joint panel according to claim 1, wherein each of the first and second sections has a triangle profile/pattern such that each of the first and second wings has a triangle jagged configuration.

10. The angled joint panel according to claim 1, wherein each of the first and second sections has a rectangular profile/pattern such that each of the first and second wings has a rectangular jagged configuration.

11. The angled joint panel according to claim 1, wherein at least one of the first and second sections has a fastening hole for receiving a fastener.

12. The angled joint panel according to claim 11, wherein the angled joint panel is connected to a wall panel by the fastener.

13. The angled joint panel according to claim 12, wherein the wall panel has at least one receiving hole, wherein the fastener is simultaneously received through the fastening hole of the angled joint panel and the receiving hole of the wall panel.

14. A garden bed, comprising:
one or more wall panels; and
one or more angled joint panels for connecting the one or more wall panels to form the garden bed in a desired shape, each of the one or more angled joint panel is according to claim 1.

15. The garden bed according to claim 14, wherein the desired shape includes an L shape, a U shape, a heart shape, a diamond shape, a clover shape, a cross shape, a triangle profile/shape, a pentagon shape, a hexagon shape, an octagon shape, or the like.

16. An angled joint panel for a garden bed, the angled joint panel comprising:
a first wing comprising a plurality of first curved sections;
a second wing comprising a plurality of second curved sections;
a backbone hinge adjoining the first wing and the second wing; and
wherein an angled formed between the first wing and the second wing ranges between about 1 to about 359 degree;
wherein the backbone hinge is configured to be adjustable such that the angle formed between the first wing and the second wing is adjustable for at least 90 degree;
wherein the first and second wings each has a sinusoidal configuration;
wherein at least one of the first and second curved sections has a fastening hole for receiving a fastener connecting the angled joint panel to a wall panel of the garden bed.

17. A garden bed, comprising:
one or more wall panels; and
one or more angled joint panels for connecting the one or more wall panels to form the garden bed in a desired shape, each of the one or more angled joint panel is according to claim 16.

18. The garden bed according to claim 17, wherein the desired shape includes an L shape, a U shape, a heart shape, a diamond shape, a clover shape, a cross shape, a triangle profile/shape, a pentagon shape, a hexagon shape, an octagon shape, or the like.
